(19) United States
(12) Patent Application Publication
(10) Pub. No.: US 2002/0048290 A1
(43) Pub. Date: Apr. 25, 2002

(54) Signal light chirp suppression method and semiconductor laser using the method

(76) Inventor: Hiromasa Tanaka, Tokyo (JP)

Correspondence Address: McGinn & Gibb, PLLC, 8321 Old Courthouse Road, Suite 200, Vienna, VA, 22182-3817, US

(21) Appl. No.: 09/981,884

(22) Filed: Oct. 19, 2001

(30) Foreign Application Priority Data
Oct. 20, 2000 (JP) 321102/2000

(51) Int. Cl. H01S 3/10

(52) U.S. Cl. 372/25

(57) ABSTRACT

In a conventional type method of suppressing the frequency chirp of signal light and a conventional type semiconductor laser using the method, high voltage is required to suppress the chirp and the speed of a response is not enough. The frequency chirp of signal light is also effectively reduced in high-speed modulation by adding another electroabsorption-type optical modulator for suppressing chirp to a semiconductor laser integrated with an electroabsorption-type optical modulator for modulating a signal.

### BACKGROUND OF THE INVENTION

1. Field of the Invention

The present invention relates to a method of suppressing the chirp of signal light and a semiconductor laser using the method.

2. Description of the Related Prior Art

In a method of directly modulating current for driving a semiconductor laser and transmitting an optical signal, the waveform of an optical signal is apt to be distorted by the effect of relaxation oscillation which a semiconductor laser has. At the leading edge and the trailing edge of an optical signal, the chirp of a transmission wavelength is caused and the chirp of the wavelength causes the spread of optical pulse length because of a wavelength dispersive characteristic which an optical fiber has. For the above-mentioned reason, the method of directly modulating current for driving a semiconductor laser and transmitting an optical signal is unsuitable for high-speed and long-distance optical transmission.

For a method of avoiding the deterioration of an optical signal waveform and the spread of an optical pulse length, a method that a semiconductor laser is oscillated with direct current and an external optical modulator modulates the dc output light of the semiconductor laser has been adopted. In this method, a waveguide Mach-Zehnder optical modulator which does not apply phase deviation that causes chirp in modulation due to the change of a refractive index to light is often used. This modulator is mainly made of ferroelectric crystal material such as lithium niobate having an electro-optic effect. It is difficult to integrate this material and a semiconductor laser to form a integrated photonic device. As electro-optic effect which is the change of a refractive index caused by an applied electric field is very small, there is a problem that the optical modulator is large-sized.

In the meantime, an optical modulator using the electroabsorption effect in a semiconductor is characterized in that it can be integrated with a semiconductor laser and its driving power is small. However, in a conventional type optical modulator using electroabsorption effect, as the change of a refractive index is also caused at the same time as photoabsorption effect occurs by the application of an electric field, there is a problem that chirp is caused in modulated light.

For a method of solving these problems, two methods are disclosed in Japanese published unexamined patent application No. Hei 11-295673.

For a first method, an electroabsorption-type optical modulator and an electrooptical modulator are integrated with a cw semiconductor laser. The principle of chirp suppression according to this configuration is that when a voltage pulse is applied to the electroabsorption-type optical modulator, the change of a refractive index caused in the optical waveguide of the electroabsorption-type modulator is compensated by a voltage pulse applied to the next electrooptical modulator.

For a second method, an electroabsorption-type optical modulator and a carrier injection-type optical modulator are integrated with a cw semiconductor laser. The principle of chirp suppression according to this configuration is that when a voltage pulse is applied to the electroabsorption-type optical modulator, the change of a refractive index caused in the optical waveguide of the electroabsorption-type optical modulator is compensated by a current pulse applied to the next carrier injection-type optical modulator.

The method of suppressing chirp in a state in which an optical modulator for compensating a refractive index disclosed in the above-mentioned Japanese published unexamined patent application No. Hei 11-295673 is added also has a problem.

In the first method using the electrooptical modulator for compensating chirp, as an electro-optic constant which optical semiconductor material generally has is a few pm/V and is very small, the length of the device and applied voltage become so large to compensate the change of a refractive index caused in the electroabsorption-type optical modulator by the electrooptical modulator.

Also, in the second method of using the carrier injection-type optical modulator for compensating chirp, as the life time of a carrier injected into the carrier injection-type optical modulator is long, chirping compensation cannot follow the speed of signal modulation having the bit rate of 10 Gbps and further, a higher bit rate.

As described above, the semiconductor laser integrated with the disclosed electroabsorption-type optical modulator cannot suppress chirp enough. In case light is transmitted via an optical fiber having a high dispersion value in long distance, the disclosed semiconductor laser integrated with the electroabsorption-type optical modulator greatly causes the deterioration of a receiver sensitivity due to the degradation of an optical waveform, compared with a conventional type transmission light source in which a lithium niobate optical intensity modulator is connected with a semiconductor laser module exteriorly. Therefore, the electroabsorption-type optical modulator could not supersede the lithiumniobate optical intensity modulator.

The invention is made in view of problems which such a conventional type semiconductor laser integrated with the electroabsorption-type optical modulator has.

### SUMMARY OF THE INVENTION

Therefore, the object of the invention is to provide a method of effectively suppressing chirp of signal light and a semiconductor laser wherein another electroabsorption-type optical modulator for suppressing chirp is added to a conventional type semiconductor laser integrated with an electroabsorption-type optical modulator and which can reduce chirp (the variation of an optical frequency) even in high-speed modulation.

In the method of suppressing the chirp of signal light according to the invention, the chirp caused in modulation of signal light acquired by modulating output light from the semiconductor laser by electric field photoabsorption effect which a first electroabsorption-type optical modulator has is suppressed by electric field photoabsorption effect which a second electroabsorption-type optical modulator has. Both a case that relation between the positive/negative polarity of a signal for driving the electroabsorption-type optical modulator and polarity in which the change of a refractive index caused in the electroabsorption-type optical modulator increases/decreases by the application of the driving signal is the same in the first and second electroabsorption-type optical modulators and a case that the relation is different in the first and second electroabsorption-type optical modulators are effective. The phases of two driving signals are off and the time of delay is substantially equal to time required for output light from the semiconductor laser to reach the second electroabsorption-type optical modulator from the first electroabsorption-type optical modulator. For electroabsorption effect, Franz-Keldysh effect or quantum confined Stark effect (QCSE) is used.

Also, the semiconductor laser according to the invention is provided with a semiconductor laser, a first electroabsorption-type optical modulator that transmits output light from the semiconductor laser and a second electroabsorption-type optical modulator that transmits output light from the first electroabsorption-type optical modulator and the second electroabsorption-type optical modulator suppresses the chirp of signal light. The semiconductor laser continuously oscillates, the first electroabsorption-type optical modulator modulates the intensity of output light from the semiconductor laser according to a first driving signal and outputs it, the second electroabsorption-type optical modulator suppresses chirp caused in the output light of the first electroabsorption-type optical modulator according to a second driving signal and outputs it. Relation between the positive/negative polarity of a driving signal and polarity in which the change of a refractive index caused in the electroabsorption-type optical modulator increases/decreases by the application of the driving signal is the same in the first and second electroabsorption-type optical modulators.

In another semiconductor laser, relation between the positive/negative polarity of a driving signal and polarity in which the change of a refractive index caused in the electroabsorption-type optical modulator increases/decreases by the application of the signal is different in the first and second electroabsorption-type optical modulators.

Also, a semiconductor laser according to the invention is provided with means for controlling the oscillation condition of a semiconductor laser, first optical modulator driving means for generating a signal for driving a first electroabsorption-type optical modulator and second optical modulator driving means for generating a signal for driving a second electroabsorption-type optical modulator. The second optical modulator driving means is further provided with means for delaying timing by time substantially equal to time required for output light from the semiconductor laser to reach the second electroabsorption-type optical modulator from the first electroabsorption-type optical modulator for the driving timing of the first electroabsorption-type optical modulator and generating a signal for driving the second electroabsorption-type optical modulator at the driving timing of the first electroabsorption-type optical modulator. Also, either of the first optical modulator driving means or the second optical modulator driving means is provided with an attenuator for regulating the level of signals for driving the two electroabsorption-type optical modulators. There are a case that the driving signal of the first electroabsorption-type optical modulator and the driving signal of the second electroabsorption-type optical modulator are out of phase and a case that they are in phase.

Of the three components of the semiconductor laser, the first electroabsorption-type optical modulator and the second electroabsorption-type optical modulator, at least the semiconductor laser and the first electroabsorption-type optical modulator are integrated monolithically or in the shape of a hybrid integrated circuit. Electric field photoabsorption effect which the electroabsorption-type optical modulator has is Franz-Keldysh effect or quantum confined Stark effect (QCSE.

### BRIEF DESCRIPTION OF THE DRAWINGS

The above and other objects, features and advantages of the present invention will become apparent from the following detailed description when taken with the accompanying drawings in which:

FIG. 1 explains the structure and the operation of a semiconductor laser integrated with a conventional electroabsorption-type optical modulator;

FIG. 2 is a circuit block diagram for the conventional type semiconductor laser shown in FIG. 1;

FIG. 3 is a structural drawing showing another semiconductor laser integrated with a conventional electroabsorption-type optical modulator different from the one shown in FIG. 1;

FIG. 4 is a structural drawing showing more one another semiconductor laser integrated with a conventional electroabsorption-type optical modulator different from the one shown in FIG. 3;

FIGS. 5A and 5B quantatively explain the change of a photoabsorption coefficient and the change of a refractive index in a electroabsorption effect;

FIGS. 6A and 6B show quantitatively calculated examples in which the change of an absorption coefficient and the change of a refractive change in a electroabsorption effect;

FIG. 7 is a structural sectional view showing a first embodiment of the semiconductor laser according to the invention;

FIG. 8 is a block diagram showing the first embodiment of the semiconductor laser according to the invention;

FIG. 9 is an explanatory drawing for explaining the operation of the first embodiment of the semiconductor laser according to the invention;

FIG. 10 is a structural sectional view showing a second embodiment of the semiconductor laser according to the invention;

FIG. 11 is a block diagram showing the second embodiment of the semiconductor laser according to the invention; and

FIG. 12 is an explanatory drawing for explaining the operation of the second embodiment of the semiconductor laser according to the invention.

### DETAILED DESCRIPTION OF THE PREFERRED EMBODIMENTS

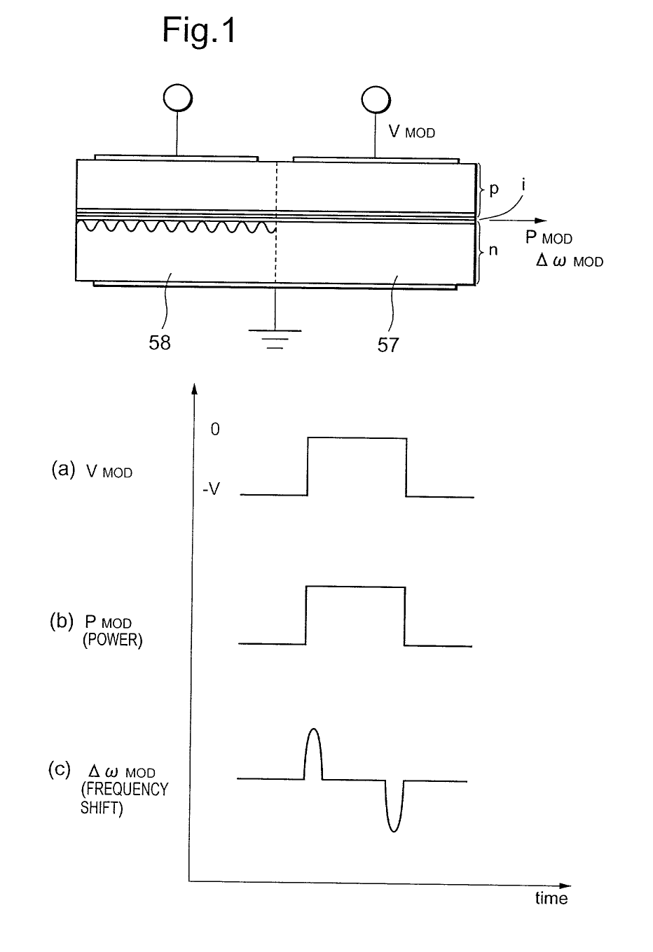

Referring to FIG. 1, a conventional semiconductor laser integrated with an electroabsorption-type optical modulator is provided with a distributed feedback semiconductor laser 58 (hereinafter called DFB-LD) and an electroabsorption-type optical modulator 57 (hereinafter called EA-MOD) integrated with DFB-LD 58. Both devices are respectively formed by laminating an N-type semiconductor layer, an i-type semiconductor layer which is an undoped layer and a P-type semiconductor layer on an N-type substrate in order by epitaxial crystal growth and respectively have p-i-n structure. Both grown layers have different composition and energy band gap. The absorption edge of the grown layers of the electroabsorption-type optical modulator is shorter than the oscillation wavelength of DFB-LD and the modulator transmits the oscillation wavelength of DFB-LD in a state in which no electric field is applied.

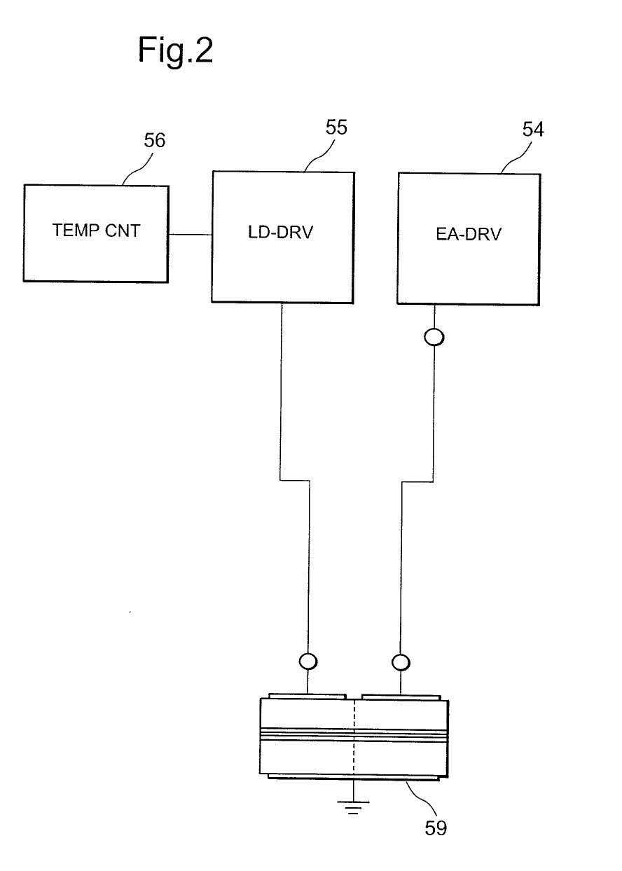

Referring to FIG. 2, an electroabsorption-type optical modulator shares an electrode on the negative side 59 with a semiconductor laser and the electrode 59 is grounded. The respective electrodes on the positive side are respectively connected to an LD driving circuit (LD-DRV) 54 and an electroabsorption-type optical modulator driving circuit (EA-DRV) 55. LD-DRV outputs direct current and makes DFB-LD oscillate CW. A temperature controller (TEMP-CNT) 56 stabilizes the oscillation output and an oscillation wavelength of DFB-LD.

Referring to FIG. 1, when the electrode on the positive side is 0 V (V_{mod}=0), output light from DFB-LD is not absorbed, is transmitted in the modulator, when voltage of −V is applied (V_{mod}=−V), output light from DFB-LD is absorbed by the electroabsorption effect of the modulator ((a) V_{mod} shown in FIG. 1) and as a result, the pulse modulation of light is performed ((b) P_{mod} shown in FIG. 1). As the change of a refractive index is also caused in the device together with the electric field photoabsorption effect, chirpings occur in transmitted light at the leading edge and the trailing edge of the pulse ((c) Δω_{mod} shown in FIG. 1). Chirp deteriorates an optical waveform through the wavelength dispersion of the group velocity of an optical fiber in long distance optical transmission.

For a method of solving this problem, two methods are disclosed in Japanese published unexamined patent application No. Hei 11-295673.

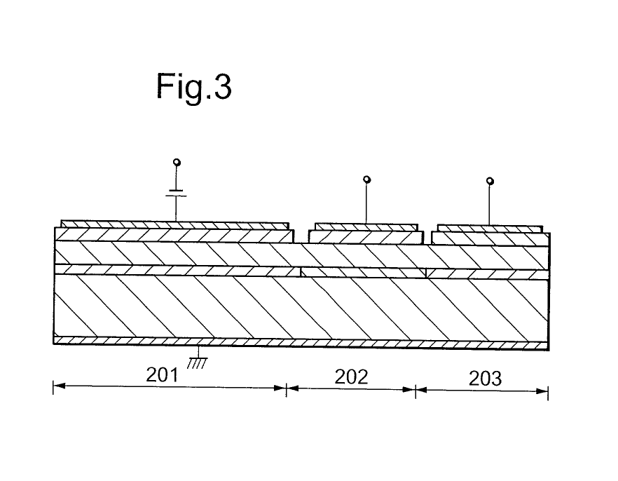

A first method has configuration shown in FIG. 3, an electroabsorption-type optical modulator 202 is integrated with a semiconductor laser 201 and further, an electrooptical modulator 203 is integrated. The principle of suppressing chirp according to the configuration is as follows. That is, when a voltage pulse is applied to the electroabsorption-type optical modulator 202, the chirp of the wavelength of transmitted light caused by the change of the refractive index of an optical waveguide of the electroabsorption-type optical modulator 202 is compensated by a voltage pulse applied to the next electrooptical modulator 203.

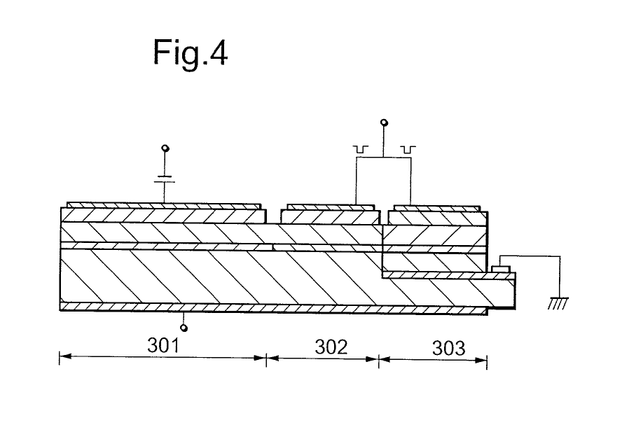

A second method has configuration shown in FIG. 4, an electroabsorption-type optical modulator 302 is integrated with a semiconductor laser 301 and further, a carrier injection-type optical modulator 303 is integrated. For the principle of suppressing chirp according to the configuration, when a voltage pulse is applied to the electroabsorption-type optical modulator 302, the chirp of the wavelength of transmitted light caused by the change of the refractive index of an optical waveguide of the electroabsorption-type optical modulator 302 is compensated by a current pulse applied to the next carrier injection-type optical modulator 303. However, the above-mentioned chirp suppression method of adding the conventional type optical modulator for compensating a refractive index has a problem.

As described above, in the first method of using the electrooptical modulator for an optical modulator for compensating chirp, as an electrooptic constant which optical semiconductor material generally has is a few pm/V and has only very small effect, the length of the device and applied voltage become unrealizable size and magnitude to compensate the change of a refractive index caused in the electroabsorption-type optical modulator by the electrooptic modulator.

Also, in the second method of using the carrier injection-type optical modulator for the optical modulator for compensating chirp, as the life time of a carrier injected in the waveguide of the carrier injection-type optical modulator is long, compensation cannot follow a signal modulation speed of a bit rate of 10 Gbps or a higher bit rate.

Referring to the drawings, embodiments of the invention will be described below.

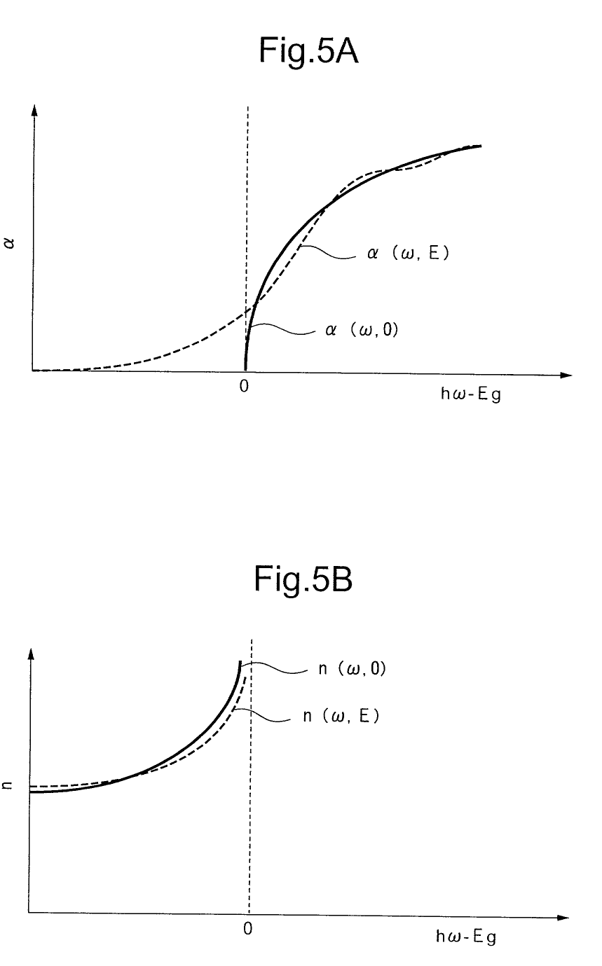

FIG. 5 qualitatively explain the change of a photoabsorption coefficient a shown in FIG. 5A in the vicinity of the intrinsic absorption edge and the change of a refractive index n shown in FIG. 5B respectively when an electric field is applied to a semiconductor crystal. “α(ω), 0)” and “n(ω, 0)” respectively denote an absorption coefficient and a refractive index when no electric field is applied and α(ω, E) and n(ω, E) respectively denote an absorption coefficient and a refractive index when an electric field the magnitude of which is E is applied. The x-axis shows the displacement of a wavelength of transmitted light from the absorption edge by energy. Eg denotes band gap energy, ω denotes the frequency of a light wave and h denotes a Planck's constant. When an electric field is applied to a crystal, the absorption edge shifts to a long wavelength (red shift) as shown by a dotted line in FIG. 5A, a carrier is generated by the absorption of light in the vicinity of the absorption edge and a refractive index in a transmission wavelength region decreases (carrier plasma effect) (see FIG. 5B).

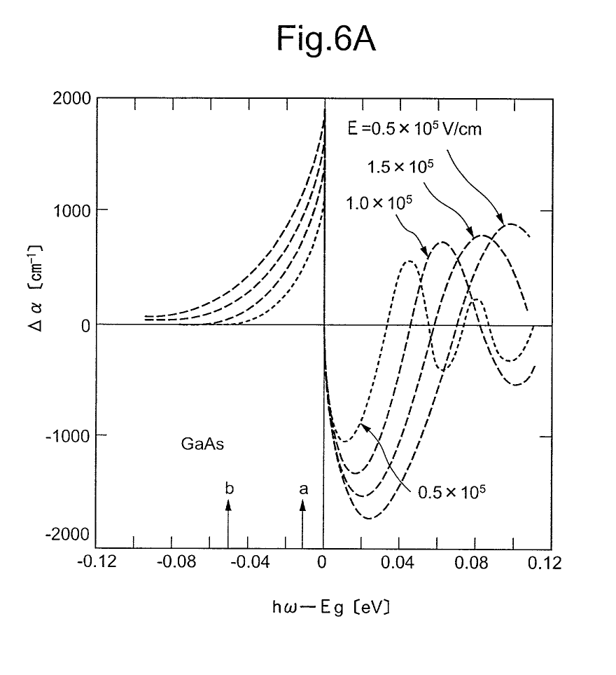

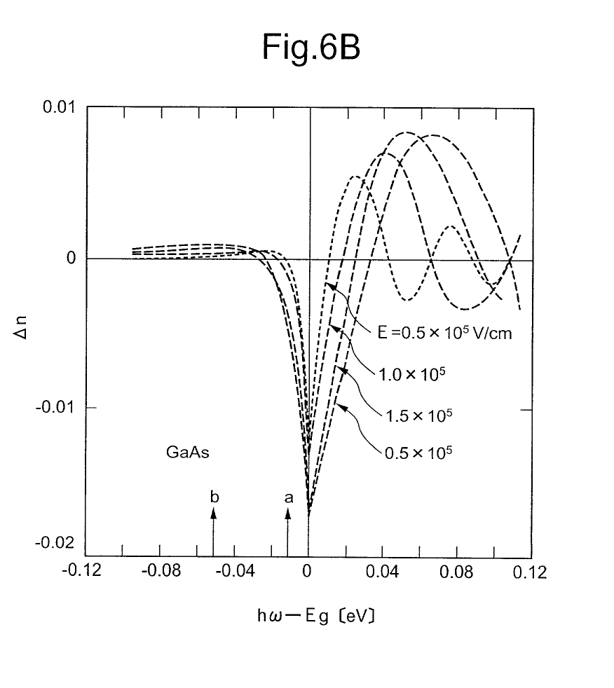

FIG. 6 show examples in case a semiconductor crystal is GaAs in which the change of an absorption coefficient and the change of a refractive index in an electroabsorption effect are quantatively calculated. FIG. 6A shows the change Δα of an optical absorption coefficient for an applied electric field and FIG. 6B shows the change of Δn of a refractive index. This data is shown on a page 365 of “Introduction to Optical Material” written by Keiei Kudo and published on Jul. 30, 1977 by Ohm.

When an electric field of 1×10⁵ V/cm (E=10 V/μm) is applied to a crystal, the absorption coefficient for light (a position shown by an arrow “a” in FIG. 5) having a longer wavelength by approximately 0.01 eV from the absorption edge becomes 1000 cm⁻¹ (α=4,340 dB/cm), that is, when a crystal length transmits the length of 100 μm, the optical absorption increases by 43.4 dB. The refractive index of the crystal decreases by approximately 0.001.

Also, the absorption coefficient for light (a position shown by an arrow “b” in FIG. 5) having a longer wavelength by approximately 0.05 eV from the absorption edge becomes 100 cm⁻¹ (434 dB/cm), that is, when light is transmitted in the length of 100 μm, the absorption increases by 4.34 dB and the refractive index of the crystal increases by approximately 0.001. Based upon the above-mentioned information of electric field photoabsorption effect, the embodiments of the invention will be described in detail below.

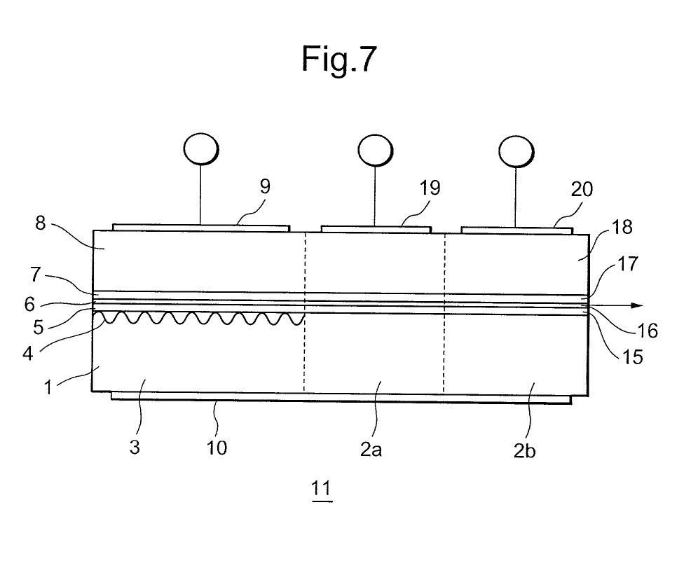

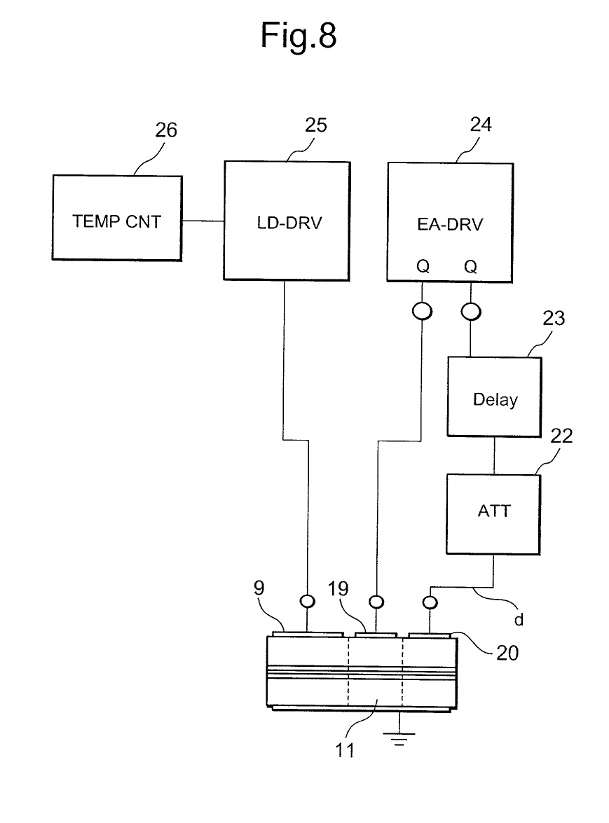

FIG. 7 shows the configuration of a device equivalent to a first embodiment of the invention and FIG. 8 is a block diagram showing a circuit for driving the device.

FIG. 7 is a structural drawing showing a semiconductor laser 11 integrated with an electroabsorption-type optical modulator according to the invention. The semiconductor laser 11 integrated with the electroabsorption-type optical modulator is provided by monolithically integrating a DFB laser 1 which generates CW light, a waveguide electroabsorption-type optical modulator 2a which is provided outside a laser resonator and which modulates the intensity of CW light and another waveguide electroabsorption-type optical modulator 2b for suppressing chirp.

The DFB laser 1 a DFB grating 4 formed in an N-type semiconductor crystal substrate 3, an N-type clad layer 5 on the grating, an undoped active layer 6 on layer 5, a P-type clad layer 7 on layer 6 and a P-type contact layer 8 on layer 7 for example, they are formed by a crystal growth technique between an electrode on the positive side 9 and an electrode on the negative side 10 and the laser can oscillate CW light in a single longitudinal mode.

The waveguide electroabsorption-type optical modulators 2a and 2b have the same configuration and the same composition in this case, are respectively formed by the crystal growth of an N-type clad layer 15, an undoped photoabsorption layer 16, a P-type clad layer 17 and a P-type contact layer 18 on the same N-type semiconductor substrate as the DFB laser 1 and they are respectively formed between an electrode on the positive side 19 and the electrode on the negative side 10 and between an electrode on the positive side 20 and the electrode on the negative side 10.

The DFB laser 1, the waveguide electroabsorption-type optical modulator 2a and the waveguide electroabsorption-type optical modulator 2b are respectively electrically isolated. The waveguide electroabsorption-type optical modulator 2a functions as an optical modulator for modulating CW light and the waveguide electroabsorption-type optical modulator 2b functions as an optical modulator for reducing chirp caused in the waveguide electroabsorption-type optical modulator 2a.

The undoped active layer 6 of the DFB laser 1 and the undoped photoabsorption layers 16 of the waveguide electroabsorption-type optical modulators 2a and 2b are different in composition and are different in band gap energy Eg. The oscillation wavelength of the DFB laser 1 is set so that it is longer than the wavelengths at the absorption edge of the waveguide electroabsorption-type optical modulators 2aand 2b.

Technology for growing semiconductor crystal layers having different composition on the same substrate and monolithically integrating devices different in a function is disclosed in Japanese published unexamined patent application No. Hei6-102476, “SEMICONDUCTOR MODULATOR, SEMICONDUCTOR DETECTOR AND INTEGRATED LIGHT SOURCE AND MANUFACTURING METHOD THEREOF” for example.

That is, in a process for the crystal growth of grown layers 5, 6 and 7 of the DFB laser 11 and grown layers 15, 16 and 17 of the waveguide electroabsorption-type optical modulators 2aand 2b, crystal layers having different band gaps can be grown by covering both sides of a grown part (active region/photo-absorption region) on a wafer with SiO₂ and providing the SiO₂ cover so that the width is wide in a region in which the laser is grown and the width is narrow in a region in which the optical modulator is grown.

In the semiconductor laser 11 integrated with the electroabsorption-type optical modulator equivalent to the first embodiment, relation between the wavelength of the absorption edge which the waveguide electroabsorption-type optical modulators 2a and 2b respectively have and the oscillation wavelength of the DFB laser 1 is set so that both modulators are under the condition shown as “a” or “b” in FIG. 6A or FIG. 6B. In the following description of the operation, a case in which the composition is set on a condition shown as “a” in FIG. 6 that when an electric field is applied, the refractive index of transmitted light decreases will be described.

FIG. 8 shows circuit configuration for driving the semiconductor laser 11 integrated with the electroabsorption-type optical modulator equivalent to this embodiment. A driving circuit is provided with LD-DRV 25 for controlling the DFB laser, TEMP-CNT 26 for transmitting a temperature control signal to LD-DRV and EA-DRV 24 for sending the electroabsorption-type optical modulators 2a and 2b. EA-DRV 24 has differential data output terminals composed of a positive phase output terminal (Q) and an anti-phase output terminal (\overline{Q}). The positive phase output terminal (Q) is connected to an electrode 19 of the electroabsorption-type optical modulator 2a for modulating a signal of the semiconductor laser 11 integrated with the electroabsorption-type optical modulator and the anti-phase output terminal (\overline{Q}) is connected to an electrode 20 of the electroabsorption-type optical modulator 2b of the semiconductor laser 11 integrated with the electroabsorption-type optical modulator via a delay circuit 13 and an attenuator 12.

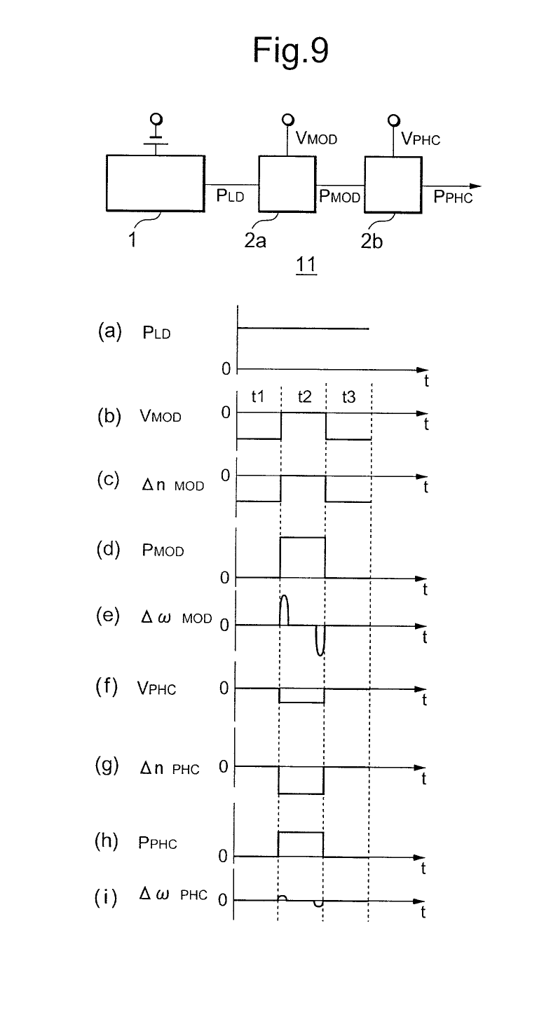

Referring to FIG. 9, the operation of the semiconductor laser 11 integrated with the electroabsorption-type optical modulator equivalent to the first embodiment will be described below.

The semiconductor laser 11 integrated with the electroabsorption-type optical modulator shown in FIG. 9 is shown in a state in which it is virtually decomposed into three device blocks of a DFB laser 1, a waveguide electroabsorption-type optical modulator 2a and a waveguide electroabsorption-type optical modulator 2b. The optical output of the DFB laser 1 is shown as P_{LD}, the optical output of the waveguide electroabsorption-type optical modulator 2a is shown as P_{MOD}, the driving voltage is shown as V_{MOD}, the optical output of the waveguide electroabsorption-type optical modulator 2b is shown as P_{PHC} and the driving voltage is shown as V_{PHC}. (a) to (i) in FIG. 9 show the time variation of each voltage waveform and physical parameters. Out of the physical parameters, Δn shows the change of the refractive index of a waveguide when voltage is applied to the waveguide electroabsorption-type optical modulator and Δω shows the frequency variation of output light. The output (Q) of a positive phase from EA-DRV 24 corresponds to a waveform shown in (b) and the output of the anti-phase (\overline{Q}) corresponds to a waveform shown in (f).

Voltage which is negative in a time slot t1, is zero in t2, is negative in t3 and the amplitude of which is V_{MOD} is applied to the waveguide electroabsorption-type optical modulator 2a ((b) in FIG. 9). When negative voltage is applied, photoabsorption occurs in the photoabsorption layer of the waveguide electroabsorption-type optical modulator 2a and simultaneously, the decrease of a refractive index occurs ((c) Δn_{MOD} in FIG. 9). For the hourly variation of the intensity of light output from the waveguide electroabsorption-type optical modulator 2a, the light is vanished in time slots t1 and t3 and in a time slot t2, light is transmitted and output ((d) P_{MOD} in FIG. 9). The frequency of an output light wave varies in transition duration in which the refractive index decreases or increases ((e) Δω_{MOD} in FIG. 9).

Voltage V_{PHC} having a phase reverse to the voltage V_{MOD} applied to the waveguide electroabsorption-type optical modulator 2a is applied to the waveguide electroabsorption-type optical modulator 2b ((f) V_{PHC} in FIG. 9). Photoabsorption occurs in the photoabsorption layer of the optical modulator by the application of negative voltage in the time slot 2 and simultaneously, the refractive index decreases ((g) Δn_{PHC} in FIG. 9). The frequency of light transmitted in the waveguide electroabsorption-type optical modulator 2a and incident also varies in voltage transition duration in the waveguide electroabsorption-type optical modulator 2b, however, the direction of the change of voltage and the direction of the change of a refractive index simultaneously caused in transition duration are reverse in the waveguide electroabsorption-type optical modulator 2a and the waveguide electroabsorption-type optical modulator 2b and as the direction of frequency variation caused in the waveguide electroabsorption-type optical modulator 2b and the direction of frequency variation caused in the waveguide electroabsorption-type optical modulator 2a are reverse, the frequency variation is set off. Therefore, chirp caused in the waveguide electroabsorption-type optical modulator 2a is reduced by being transmitted in the waveguide electroabsorption-type optical modulator 2b ((i) Δω_{PHC} in FIG. 9).

That is, as voltage respectively applied to the electroabsorption-type optical modulator 2a and the electroabsorption-type optical modulator 2b has the relation of reverse phases by adopting the above-mentioned device configuration and driving condition, the change of a refractive index in the waveguide in the whole electroabsorption-type optical modulator 2a and electroabsorption-type optical modulator 2b is inhibited.

However, in case a symmetrical electric signal of V_{PHC}=V_{MOD} is applied, no optical output P_{PHC} (shown in (h) in FIG. 9) is output from the electroabsorption-type optical modulator 2b and the electroabsorption-type optical modulator has no meaning as a modulator. Then, the attenuator 22 is provided between the anti-phase output terminal of EA-DRV 14 and the electroabsorption-type optical modulator 2b so as to reduce the amplitude of voltage applied to the electroabsorption-type optical modulator 2b. Hereby, the chirp suppression effectiveness is reduced, however, the output of modulated light the chirp of which is more suppressed can be acquired, compared with conventional type configuration including only one electroabsorption-type optical modulator.

As a second optical modulator for compensating chirp is the electroabsorption-type optical modulator, the semiconductor laser light source integrated with the smaller-sized optical modulator can be formed, compared with a conventional type method using an electrooptical modulator. Also, a refractive index is compensated at high speed and effectively without time-lag, compared with a conventional type method using a carrier injection-type optical modulator.

In the driving circuit shown in FIG. 8, a delay element 23 is inserted between EA-DRV 24 and the attenuator 22 to correct the transit time of light between the electroabsorption-type optical modulator 2a and the electroabsorption-type optical modulator 2b so that a refractive index is effectively compensated without time-lag even if the semiconductor laser 11 integrated with the electroabsorption-type optical modulator is operated at high modulated signal speed of 10 bps or more.

As described above, as the electroabsorption-type optical modulator 2b can suppress chirp caused in the electroabsorption-type optical modulator 2a, effect that the deterioration of a waveform by dispersion after transmission via an optical fiber is reduced is produced. Further, if composition the change of a refractive index of which is larger and multi-quantum well structure are adopted for the electric field photoabsorption layers 16 of the electroabsorption-type optical modulators 2a and 2b, the effect of the compensation of a refractive index is increased and device size can be further small-sized.

Next, a second embodiment of the invention will be described.

The concept of the second embodiment of the invention is based upon the following concept. That is, referring to the result of the calculation in the case of GaAs shown in FIG. 6, the composition of the electroabsorption-type optical modulator for modulating a signal is selected so that the oscillation wavelength of the semiconductor laser corresponds to the case in the vicinity of “a” shown in FIG. 8, the composition of the electroabsorption-type optical modulator for suppressing chirp is selected so that the oscillation wavelength of the semiconductor laser corresponds to the case in the vicinity of “b” shown in FIG. 8, the above-mentioned two modulators are cascaded at the end from which light is emitted from the semiconductor laser in a direction of the transmission of light, in case the two modulators are driven in phase, the electroabsorption-type optical modulator for modulating a signal modulates the intensity of transmitted light at high extinction ratio, the electroabsorption-type optical modulator for suppressing chirp further effectively compensates the change of the phase of light due to the change of a refractive index caused in the electroabsorption-type optical modulator for modulating a signal, compared with the case in the first embodiment and can suppress chirp.

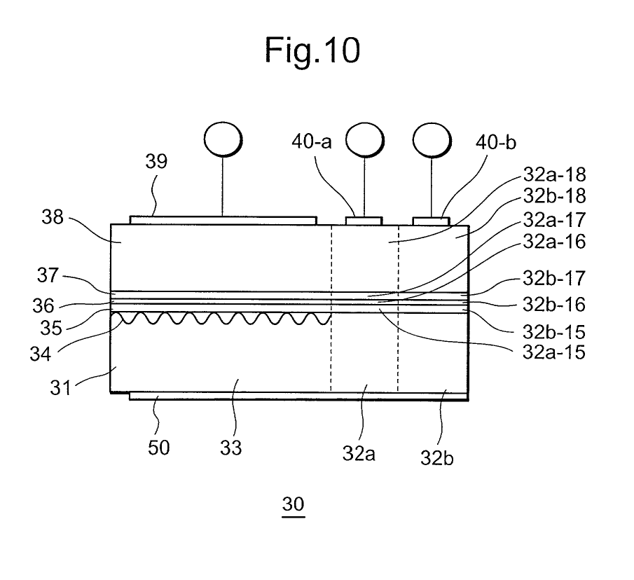

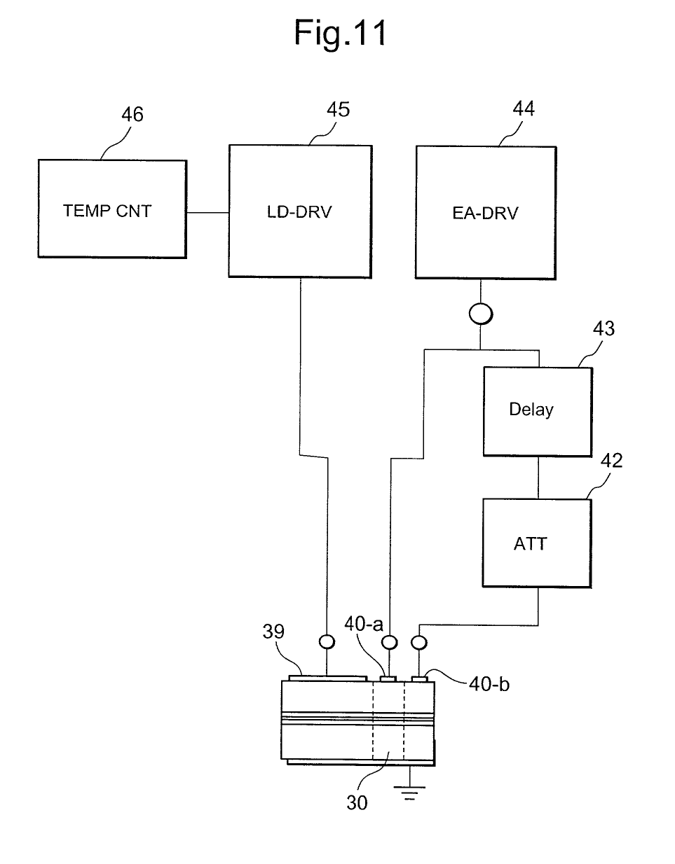

FIG. 10 shows the device configuration in the second embodiment of the invention. FIG. 11 is a circuit block diagram for driving the device.

FIG. 10 is a structural drawing showing a semiconductor laser 30 integrated with an electroabsorption-type optical modulator. The semiconductor laser 30 integrated with the electroabsorption-type optical modulator monolithically includes a DFB laser 31 that generates CW light, a waveguide electroabsorption-type optical modulator 32a which is located outside a DFB laser and modulates the intensity of CW light and another waveguide electroabsorption-type optical modulator 32b suppress the chirp.

The DFB laser 31 is provided with a grating 34 formed in an N-type semiconductor crystal substrate 33, an N-type clad layer 35 on it, an undoped active layer 36, a P-type clad layer 37 and a P-type contact layer 38 for example by crystal growth, is located between an electrode on the positive side 39 and an electrode on the negative side 50 and can oscillate CW light in a single longitudinal mode.

The waveguide electroabsorption-type optical modulators 32a and 32b are respectively provided with an N-type clad layer 32a-15 or 32b-15 on the same semiconductor substrate as the DFB laser 1, an undoped photoabsorption layer 32a-16 or 32b-16, a P-type clad layer 32a-17 or 32b-17 and a P-type contact layer 32a-18 or 32b-18 by crystal growth and is located between an electrode on the positive side 40-a or 40-b and an electrode on the negative side 10.

The DFB laser 31, the waveguide electroabsorption-type optical modulator 32a and the waveguide electroabsorption-type optical modulator 32b are respectively electrically isolated. The waveguide electroabsorption-type optical modulator 32a functions an optical modulator for modulating CW light and the waveguide electroabsorption-type optical modulator 32b functions as an optical modulator for reducing chirp caused in the waveguide electroabsorption-type optical modulator 32a.

The undoped active layer 36 of the DFB laser 31 has different composition from the undoped photoabsorption layers 32a-16 and 32b-16 of the waveguide electroabsorption-type optical modulators 32a and 32b and band gap energy Eg is different. Though the structure of the waveguide electroabsorption-type optical modulators 32a and 32b is the same, the composition of their undoped photoabsorption layers 32a-16 and 32b-16 is different and band gap energy Eg is respectively different. The oscillation wavelength of the DFB laser 31 is set so that it is located on the side of a longer wavelength than the wavelength of the absorption edge of the waveguide electroabsorption-type optical modulators 32a and 32b.

Further concretely, in FIG. 6 showing the absorption coefficient α when an electric field is applied and the change of the refractive index Δn, the undoped photoabsorption layer 32a-16 of the waveguide electroabsorption-type optical modulator 32a has composition in which the wavelength of transmitted light corresponds to the arrow “a” in FIG. 6. That is, the composition of the undoped photoabsorption layer 32a-16 is set so that when an electric field is applied, the refractive index decreases when light having the oscillation wavelength of the DFB laser 31 is transmitted in the undoped photoabsorption layer 32a-16. The undoped photoabsorption layer 32b-16 of the waveguide electroabsorption-type optical modulator 32b has composition corresponding to the arrow b in FIG. 6. That is, the composition of the undoped photoabsorption layer 32b-16 is set so that when an electric field is applied, the refractive index for light having the oscillation wavelength of the DFB laser 31 increases of the undoped photoabsorption layer 32b-16.

Technology for growing semiconductor crystal layers having different composition on the same substrate and monolithically integrating devices different in functions is disclosed in Japanese published unexamined patent application No. Hei 6-102476, “SEMICONDUCTOR MODULATOR, SEMICONDUCTOR DETECTOR AND INTEGRATED LIGHT SOURCE AND MANUFACTURING METHOD THEREOF” for example as in the first embodiment. That is, for example, in a process for growing the crystal of the active layer 36 of the DFB laser 31 and the photoabsorption layers 32a-16 and 32b-16 of the waveguide electroabsorption-type optical modulators 32a and 32b, three types of crystal layers different in a band gap can be grown on the same crystal substrate continuously by covering the crystal plane on both sides of a grown part (active region in DFB laser and photo-absorption region in modulators) with SiO₂ stripe masks and providing the width of the SiO₂ mask so that it is the widest in a region for growing the active layer 36, it is the second widest in a region for growing the photoabsorption layer 32a-16 and it is the narrowest in a region for growing the photoabsorption layer 32b-16.

FIG. 11 shows circuit configuration for driving the semiconductor laser 30 integrated with the electroabsorption-type optical modulator equivalent to this embodiment. A driving circuit is provided with LD-DRV 45 for controlling the DFB laser 31, TEMP-CNT 46 for sending a temperature control signal to DFB laser 31 and EA-DRV 44 for controlling the electroabsorption-type optical modulators 32a and 32b. The output of the EA-DRV 44 is input to the electroabsorption-type optical modulator 32a for modulating a signal of the semiconductor laser 30 integrated with the electroabsorption-type optical modulator and the electroabsorption-type optical modulator 32b for suppressing chirp via a delay circuit 43 and an attenuator 42.

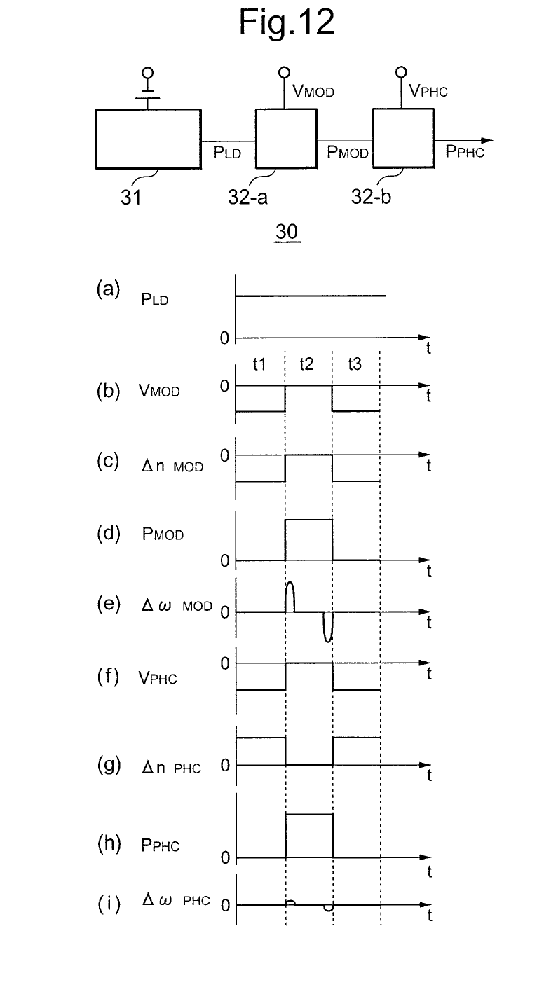

Referring to FIG. 12, the operation of the semiconductor laser integrated with the electroabsorption-type optical modulator 30 equivalent to the second embodiment of the invention will be described below.

The semiconductor laser integrated with the electroabsorption-type optical modulator 30 shown in FIG. 12 is shown in a state in which it is virtually decomposed into three device blocks of the DFB laser 31, the waveguide electroabsorption-type optical modulator 32a and the waveguide electroabsorption-type optical modulator 32b. The optical output of the DFB laser 31 is shown as P_{LD}, the optical output of the waveguide electroabsorption-type optical modulator 32a is shown as P_{MOD}, the driving voltage is shown as V_{MOD}, the optical output of the waveguide electroabsorption-type optical modulator 32b is shown as P_{PHC} and the driving voltage is shown as V_{PHC}. (a) to (i) in FIG. 12 show the hourly variation of each voltage waveform and physical parameters. Out of the physical parameters, Δn shows the change of the refractive index of a waveguide when voltage is applied to the waveguide electroabsorption-type optical modulator and Δω shows the frequency variation of output light. Voltage V_{MOD} applied to the waveguide electroabsorption-type optical modulator 32a from EA-DRV 44 corresponds to a waveform shown in (b) in FIG. 12 and voltage V_{PHC} applied to the waveguide electroabsorption-type optical modulator 32b corresponds to a waveform shown in (f) in FIG. 12. Voltage having a waveform which becomes negative in a time slot t1, becomes zero in t2, becomes negative in t3 and the amplitude of which is V_{MOD} is applied to the waveguide electroabsorption-type optical modulator 32a ((b) V_{MOD} in FIG. 12). When negative voltage is applied, photoabsorption occurs in the photoabsorption layer of the waveguide electroabsorption-type optical modulator 32a and simultaneously, the decrease of a refractive index occurs ((c) Δn_{MOD} in FIG. 12). For the hourly variation of the intensity of light output from the waveguide electroabsorption-type optical modulator 32a, light is output in the time slot t2 in which no voltage is applied in a time slot t2 ((d) P_{MOD} in FIG. 12) and the frequency of an output light wave varies in transition duration in which the refractive index decreases or increases ((e) Δω_{MOD} in FIG. 12).

Light transmitted in the waveguide electroabsorption-type optical modulator 32a is incident on the waveguide electroabsorption-type optical modulator 32b. Voltage having a negative waveform in the time slot t1, a waveform of zero in t2 and a negative waveform in t3 and the amplitude of which is V_{PHC} is applied to the waveguide electroabsorption-type optical modulator 32b ((f) V_{PHC} in FIG. 12). This voltage is in phase with voltage V_{MOD} applied to the waveguide electroabsorption-type optical modulator 32a. A refractive index increases when no voltage is applied in the time slot 2 ((g) Δn_{PHC} in FIG. 12). The output light of the waveguide electroabsorption-type optical modulator 32b is output from the waveguide electroabsorption-type optical modulator 32b without being attenuated because no voltage is applied in the time slot t2 ((h) P_{PHC} in FIG. 12). The direction of the change of a refractive index caused in the waveguide electroabsorption-type optical modulator 32b is reverse to the direction of the change of a refractive index caused in the waveguide electroabsorption-type optical modulator 32a. Therefore, as the direction of frequency variation applied to light by the waveguide electroabsorption-type optical modulator 32b is reverse to the direction of variation caused in the waveguide electroabsorption-type optical modulator 32a and the frequency variation is set off, chirp caused in the waveguide electroabsorption-type optical modulator 32a is set off in the waveguide electroabsorption-type optical modulator 32b ((e) Δω_{PHC} in FIG. 12).

That is, in the configuration of this embodiment, as the electroabsorption-type optical modulator 32a and the electroabsorption-type optical modulator 32b are different in composition and have reverse codes in the change of a refractive index for applied voltage though voltage respectively applied to the electroabsorption-type optical modulator 32a and the electroabsorption-type optical modulator 32b is in phase, the change of a refractive index applied to light by the electroabsorption-type optical modulator 32a is inhibited by being transmitted in the electroabsorption-type optical modulator 32b. In this embodiment, as electric field light is absorbed in the time slots t1 and t3 in the waveguide electroabsorption-type optical modulators 32a and 32b, distance between the devices can be reduced and voltage applied to the individual optical modulator can be reduced.

In the driving circuit shown in FIG. 11, the attenuator 42 is provided between EA-DRV 44 and the electroabsorption-type optical modulator 32b so as to regulate voltage applied to the two electroabsorption-type optical modulators. Also, a delay element 43 is inserted between EA-DRV 44 and the attenuator 42 to correct the transit time of light between the electroabsorption-type optical modulator 32a and the electroabsorption-type optical modulator 32b.

In the described-mentioned embodiments, the case that the active layer of the DFB laser and the photoabsorption layers of the electroabsorption-type optical modulators are integrated is described above and the case that Franz-Keldysh effect is used for electric field photoabsorption effect is described above, however, if the active layer of the DFB laser and the photoabsorption layers of the electroabsorption-type optical modulators have quantum well structure, Quantum Confined Stark Effect (QCSE) can be utilized for electric field photoabsorption effect and as the absorption edge has a characteristic that the leading edge is abrupt for a wavelength, the wavelength of transmitted light can further approach the absorption edge and the sensitivity of modulation is enhanced.

In the embodiments of the invention, the case that the DFB laser and the electroabsorption-type optical modulators are monolithically integrated is described above, however, needless to say, the semiconductor laser according to the invention may be also composed of discrete devices and they may be also hybridized.

As described above, the semiconductor laser according to the invention can also reduce chirp caused in signal light in high-speed modulation by adding another electroabsorption-type optical modulator for suppressing chirp to the semiconductor laser integrated with the electroabsorption-type optical modulator for modulating a signal.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A signal light frequency chirp suppression method, wherein:
the frequency chirp caused in the modulation of signal light acquired by modulating a light output from a semiconductor laser by electroabsorption effect which a first electroabsorption-type optical modulator has is suppressed by electric field photoabsorption effect which a second electroabsorption-type optical modulator has suppresses chirp caused in the modulation.

2. A frequency chirp suppression method according to claim 1, wherein:
the first electroabsorption-type optical modulator modulates the intensity of light output from the semiconductor laser according to a first driving signal and outputs; and
the second electroabsorption-type optical modulator suppresses the chirp of the frequency of light output from the first electroabsorption-type optical modulator according to a second driving signal and outputs.

3. A frequency chirp suppression method according to claim 2, wherein:
relation between the positive/negative polarity of the driving signal and the increase/decrease of the change of a refractive index caused in the electroabsorption-type optical modulator by the application of the driving signal is the same in the first and second electroabsorption-type optical modulators.

4. A frequency chirp suppression method according to claim 2, wherein:
relation between the positive/negative polarity of the driving signal and the increase/decrease of the change of a refractive index caused in the electroabsorption-type optical modulator by the application of the signal is different in the first and second electroabsorption-type optical modulators.

5. A frequency chirp suppression method according to claim 2, wherein:
the phase of the second driving signal is delayed for the phase of the first driving signal.

6. A frequency chirp suppression method according to claim 5, wherein:
the time of the delay is substantially equal to time required for light output from the semiconductor laser to be transmitted from the first electroabsorption-type optical modulator to the second electroabsorption-type optical modulator.

7. A frequency chirp suppression method according to claim 1, wherein:
electroabsorption effect which either of the two electroabsorption-type optical modulators has is Franz-Keldysh effect.

8. A frequency chirp suppression method according to claim 1, wherein:
electroabsorption effect which the two electroabsorption-type optical modulators have is both Franz-Keldysh effect.

9. A frequency chirp suppression method according to claim 1, wherein:
electroabsorption effect which either of the two electroabsorption-type optical modulators has is quantum confined Stark effect (QCSE).

10. A frequency chirp suppression method according to claim 1, wherein:
electroabsorption effect which the two electroabsorption-type optical modulators have is both quantum confined Stark effect (QCSE).

11. A semiconductor laser provided with a method of suppressing signal light frequency chirp, comprising:
a semiconductor laser;
a first electroabsorption-type optical modulator that transmits light output from the semiconductor laser; and
a second electroabsorption-type optical modulator that transmits the light output from the first electroabsorption-type optical modulator.

12. A semiconductor laser according to claim 11, wherein:
the semiconductor laser continuously oscillates.

13. A semiconductor laser according to claim 11, wherein:
the first electroabsorption-type optical modulator modulates the intensity of light output from the semiconductor laser according to a first driving signal and outputs; and
the second electroabsorption-type optical modulator suppresses the chirp of the frequency caused in the light output from the first electroabsorption-type optical modulator according to a second driving signal and outputs.

14. A semiconductor laser according to claim 13, wherein:
relation between the positive/negative polarity of the driving signal and the increase/decrease of the change of a refractive index caused in the electroabsorption-type optical modulator by the application of the driving signal is the same in the first and second electroabsorption-type optical modulators.

15. A semiconductor laser according to claim 13, wherein:
relation between the positive/negative polarity of the driving signal and the increase/decrease of the change of a refractive index caused in the electroabsorption-type optical modulator by the application of the signal is different in the first and second electroabsorption-type optical modulators.

16. A semiconductor laser according to claim 11, wherein:
the phase of the second driving signal is delayed for the phase of the first driving signal.

17. A semiconductor laser according to claim 11, wherein:
the time of the delay is substantially equal to time required for light output from the semiconductor laser to be transmitted from the first electroabsorption-type optical modulator to the second electroabsorption-type optical modulator.

18. A semiconductor laser according to claim 11, further comprising:
means for controlling the oscillation condition of the semiconductor laser;
first optical modulator driving means for generating a signal for driving the first electroabsorption-type optical modulator; and
second optical modulator driving means for generating a signal for driving the second electroabsorption-type optical modulator.

19. A semiconductor laser according to claim 18, wherein:
the second optical modulator driving means is further provided with means for delaying timing by time substantially equal to time required for light output from the semiconductor laser to be transmitted from the first electroabsorption-type optical modulator to the second electroabsorption-type optical modulator for the driving timing of the first electroabsorption-type optical modulator and generating the signal for driving the second electroabsorption-type optical modulator.

20. A semiconductor laser according to claim 18, wherein:
either of the first optical modulator driving means or the second optical modulator driving means is provided with an attenuator for regulating the driving signal levels of the two electroabsorption-type optical modulators.

21. A semiconductor laser according to claim 14, wherein:
a signal for driving the first electroabsorption-type optical modulator and a signal for driving the second electroabsorption-type optical modulator are in phase.

22. A semiconductor laser according to claim 15, wherein:
a signal for driving the first electroabsorption-type optical modulator and a signal for driving the second electroabsorption-type optical modulator are out of phase.

23. A semiconductor laser according to claim 11, wherein:
at least the semiconductor laser and the first electroabsorption-type optical modulator of three components of the semiconductor laser, the first electroabsorption-type optical modulator and the second electroabsorption-type optical modulator are monolithically integrated.

24. A semiconductor laser according to claim 11, wherein:
the semiconductor laser, the first electroabsorption-type optical modulator and the second electroabsorption-type optical modulator are monolithically integrated.

25. A semiconductor laser according to claim 11, wherein:
at least the semiconductor laser and the first electroabsorption-type optical modulator of three components of the semiconductor laser, the first electroabsorption-type optical modulator and the second electroabsorption-type optical modulator are hybridized.

26. A semiconductor laser according to claim 11, wherein:
the semiconductor laser, the first electroabsorption-type optical modulator and the second electroabsorption-type optical modulator are hybridized.

27. A semiconductor laser according to claim 11, wherein:
the semiconductor laser is a distributed feedback semiconductor laser (DFB-LD).

28. A semiconductor laser according to claim 11, wherein:
electroabsorption effect which either of the two electroabsorption-type optical modulators has is Franz-Keldysh effect.

29. A semiconductor laser according to claim 11, wherein:
electroabsorption effect which the two electroabsorption-type optical modulators have is both Franz-Keldysh effect.

30. A semiconductor laser according to claim 11, wherein:
electroabsorption effect which either of the two electroabsorption-type optical modulators has is quantum confined Stark effect (QCSE).

31. A semiconductor laser according to claim 11, wherein:
electric field photoabsorption effect which the two electroabsorption-type optical modulators have is both quantum confined Stark effect (QCSE).
